(19) United States
(12) Patent Application Publication
(10) Pub. No.: US 2005/0038876 A1
(43) Pub. Date: Feb. 17, 2005

(54) System and method for instant match based on location, presence, personalization and communication

(76) Inventor: Aloke Chaudhuri, Victor, NY (US)

Correspondence Address: ALOKE CHAUDHURI, 6698 SETTERS RUN, VICTOR, NY, 14564, US

(21) Appl. No.: 10/917,931

(22) Filed: Aug. 14, 2004

Related U.S. Application Data
(60) Provisional application No. 60/495,145, filed on Aug. 15, 2003.

(51) Int. Cl. G06F 15/16; G06F 17/30

(52) U.S. Cl. 709/219

(57) ABSTRACT

A system and method is described for instantly connecting and matching people and business entities with reciprocal interests in the location of their presence in real-time. Portable communication devices using wireless communication are used for transmitting data between users with reciprocal interests connected through a peer-to-peer network or in a client-server environment. Telephone users utilize an Interactive Voice Response system to communicate with other users of reciprocal interest. A matching algorithm running in a remote computer connected to the devices through network makes an initial assessment about the likelihood of a match, and then with the permission of the requester and the respondent, sets up communication sessions.

### CROSS REFERENCE TO RELATED APPLICATIONS

The present application claims priority on U.S. provisional application Ser. No. 60/495,145 filed Aug. 15, 2003 for SYSTEM AND METHOD FOR INSTANT CONNECT, the disclosure of which is hereby incorporated by reference.

### BACKGROUND OF THE INVENTION

I. Field of the Invention

The present invention relates to telecommunication systems, business process and computer software, and more specifically, to a system and method for instantly connecting and matching people and business entities with reciprocal interests in the location of their presence in real-time.

II. Description of the Related Art

With the increasing popularity of the Internet and wireless networks, the fundamental aspects of business and social interaction are undergoing major changes worldwide. In the fast-paced world that we live in today, there is a growing demand for technology based targeted networking to effectively deal with work and lifestyle issues.

On the Internet, social networking started as online dating services and is spreading its wings to match people with similar interests in anything from sports to music to business and politics. Basically to start a social network, someone posts a profile on a social networking site and invites their friends to do the same. Soon there is an entire network connecting like-minded people with the potential to spread endlessly around the world. One can join most social networking sites simply by registering and posting their profile. Some of well-known social networking sites like Friendster.com, Ryze.com, Linkedin.com, Meetup.com, and Orkut.com offer both business and social networking. But these Internet based portals fails to address the need for people to match with one another in the location of their presence in real-time. Voice, video, and web collaboration is not designed to replace in-person interaction, it complements it by creating an environment that is as close as possible to being there and enabling people to work and communicate effectively over distances. Moreover, due to the virtual nature of the Internet, privacy and security issues often outweigh the benefits of such interaction. Behind the veil of Internet secrecy, people with questionable background have the means to alter their image and fake their identity to fit a more desirable profile. Accordingly, a solution is needed that can combine the convenience of online business and social networking with the benefits of traditional in-person interaction.

Location Based Services (LBS) have provided a partial solution to the problem. They exploit GPS or E911 positioning technologies for knowing where a user is geographically located, and then provide content specific to that location. It can overcome some of the issues encountered by static Internet based portals mentioned above. But instead of social and business networking, their focus have mostly been on providing point-of-interest (POI) and event searching services. POI services helps to locate nearby information items, such as ATM machines, hotels, parking garages and restaurants. Event searching services makes it easy to locate movie theaters, parties and concerts that take place in the user's immediate area at a specific date and time. Solution providers in this category also offer location-based information retrieval and advertising services, which operates in both push and pull modes to deliver text, image and video streams to mobile PDAs and cell phones. Although LBS is a promising technology, it fails to provide person-to-person communication based on location, presence and individual preferences.

In the past, several attempts have been made in a number of different countries around the world to develop solutions for location and presence based instant communication. In Japan, a device called “Lovegety” was launched in 1998. The device had three buttons that the user could set according to the kind of activity he or she had in mind: “talk,” “karaoke,” and “get2.” Once the holder selects a mode, the device searches for Lovegety holders of the opposite sex in a 15 feet radius. If it locates a holder with the same mode, the “get” light flashes and the device beeps, so the pair can find each other. While Lovegety is certainly a great tool for teenagers and had a huge commercial success in Japan, it is far from being a technically sophisticated solution that can match people based on their preferences over a great distance. Following the success of Lovegety, a Chinese company cloned the product under the name “partyBAPP”. This had a slightly bigger coverage area, but the product was nothing but a handheld device for instant messaging. In the U.S., several companies have tried similar products with Bluetooth and Infrared based short-range communication devices that can exchange personal profiles when two individuals come within the range of the device. The real value of those short-range devices is questionable since their coverage is so limited (usually several feet) that people in such close proximity may not need a device to assist them in networking. The latest in that category of solution is “Serendipity”, a networking system developed at MIT. The system uses Bluetooth, an RF (radio frequency) protocol that works like a low-power radio in most cell phones, sending out a short-range beacon. When two or more people running Serendipity come into a 16-feet bubble around them, Serendipity automatically sends an SMS to an SMS gateway server with the discovered device's ID. If a “match” is found, an MMSC sends a customized picture message introduction back to each user. While Serendipity is technically more refined than the other solutions because if its ability to provide more resources through the server, it still suffers from the inherent limitation of the short-range of Bluetooth. Further, it does not cater to the need of people using legacy cell phones with no display or messaging capabilities, or for people with visual impairment. In addition, it does not address the issue of communication between the users of disparate network and devices who are interested to participate in such interaction. Finally, instant connect and match solutions using client-server based communication cannot operate when the devices do not get access to a network.

The present invention provides a solution that can overcome the aforementioned difficulties and offer additional advantages. The solution may best be understood with some prior knowledge relative to the technologies associated with the invention, which is briefly described below.

In recent years, cellular phones and various portable communication devices, such as PDA, BlackBerry and SmartPhone, have not only become commonplace, but emerged as a hub for convergence of the world's media, e-commerce, information technology and communications industries. These portable communication devices have always enjoyed wide acceptance in many application areas due to their underlying advantage of powerful computing capabilities in a simple, inexpensive and portable form. It is only until recently they have been fully integrated with advanced wireless networking technologies, such as IEEE 802.11 a, b, or g compliant Wireless LAN (also referred as Wi-Fi) or Bluetooth. Likewise, the traditional cellular phone has morphed from a voice-only device running on a circuit switched telephony network to a powerful gadget capable of handling voice, image and data through telephony network, Wireless LAN or Bluetooth. These enhancements have made it possible to deliver a number of turnkey solutions to the global population in ways never thought possible.

In parallel with the proliferation of advanced cellular phones and portable communication devices, there has been phenomenal growth in the wireless LAN technology sector. Not long ago, wireless LANs were a novelty, and their potential was impaired by the presence of multiple competing standards: 802.11a, 802.11b, and 802.11g. First-generation WLANs had many other shortcomings, security being the most visible one, and management being another. Fortunately those things are changing in the second generation of WLAN. Dual-band or combo WLAN chip sets have eased some of the hesitancy in making a purchase decision. Innovations in wireless networking and chip technology are making it possible to access any kind of wireless network, overcoming compatibility and coexistence problems between WLAN, 3G and Bluetooth technologies. With the introduction of AES as the de-facto encryption standard for 802.11, security is poised to improve significantly. Combined with new IP telephony applications, Wi-Fi is clearly a disruptive technology that offers a tremendous opportunity to deliver innovative solutions. Most significantly, Wi-Fi is no longer confined to just enterprise networks or in people's home as they once used to be. Increasingly, public places, such as airports, hotels, and coffee shops are providing wireless access for customers. These places, referred as Public Hot Spots, offer free or paid services for Internet connectivity. They have been instrumental in the growth of the WLAN technology and its mass adoption in the market. Pundits believe Wi-Fi will have an enormous impact on all facets of technology over the next few years. Goldman Sachs has projected that more than 95 million people will become mobile Internet users by 2004, and Gartner has estimated that the revenue generated by Wi-Fi Hot Spot users will be over $9 Billion by 2007. Despite its startling growth, Wi-Fi must overcome big hurdles before it lives up to its promise. Some analysts doubt the ability of Hot Spot service providers to turn a profit in its current economic model. Arguably, wireless LANs are best used for specific applications, not simply as a general Ethernet replacement, as some have presumed. It is quite conceivable that after the novelty appeal is over, basic connectivity will not remain the key revenue driver. Future leaders in this space will be those companies who can create value-added applications and services to drive mass adoption of the technology and develop sustainable competitive advantage.

Most installed wireless LANs today utilize “infrastructure” mode that requires the use of one or more access points. With this configuration, the access point provides an interface to a distribution system (e.g., Ethernet), which enables wireless users to utilize corporate servers and Internet applications. As an optional feature, however, the IEEE 802.11 standard specifies “ad hoc” mode, which allows the radio network interface card (NIC) to operate in what the standard refers to as an Independent Basic Service Set (IBSS) network configuration. With an IBSS, there are no access points. User devices communicate directly with each other in a peer-to-peer manner. Because there is no distribution system with ad hoc wireless LANs, users don't have effective access to the Internet and other wired network services unless at least one of the users is also configured with a shared connection to the Internet. Some product vendors are beginning to base their solutions on ad hoc mode. As an example, Mesh Networks offers a wireless broadband network system based on 802.11 ad hoc mode and a patented peer-to-peer routing technology. This results in a wireless mesh topology where mobile devices provide the routing mechanisms in order to extend the range of the system. For example, a user on one side of the building can send a packet destined to another user on the far side of the facility, well beyond the point-to-point range of 802.11, by having the signal hope from client device to client device until it gets to its destination. This can extend the range of the wireless LAN from hundreds of feet to miles, depending on the concentration of wireless users.

Even though the WLAN industry in general, and the Hot Spots in particular, have experienced tremendous growth in the last few years, the large installed base of cell phones and its enabling technologies (CDMA, TDMA, GSM, GPRS, EDGE, EMTS etc.) cannot be ignored for offering any solution that has the goal to reach the maximum number of people and to enable seamless transfer of information between disparate network and devices. Public Land Mobile Network (PLMN) has evolved from a voice centric paradigm using, CDMA, TDMA or GSM to the current stage of moderately high-speed network offering data services through GPRS and CDMA 1×RTT. The evolution is continuing further to reach the next stage of 3G high-speed network employing EDGE, UMTS and CDMA 3×RTT technologies. Most cell phones now include a WAP compliant text-only web browser that offers limited Internet access, and a text messaging system usually in the form of Short Message Service (SMS). The picture phones also contain the first generation of Multimedia Messaging Service (MMS), an evolving technology that allows users to exchange multimedia communications between capable mobile phones and other devices. An extension to the SMS protocol, MMS defines a way to send and receive, almost instantaneously, wireless messages that include images, audio, and video clips in addition to text. When the technology has been fully developed, it will support the transmission of streaming video. A common current application of MMS messaging is picture messaging (the use of camera phones to take photos for immediate delivery to a mobile recipient). Other possibilities include animations and graphic presentations of stock quotes, sports news, and weather reports.

Wireless communication devices have the disadvantage of having small screens, limited input capabilities, and limited processing power. They've obviously been huge successes as voice communication conduits. However, their public acceptance rate as data delivery vehicles remain questionable. Despite the advent of technologies, such as WAP and SMS, the fact remains that accessing textual content over a small phone display is difficult and, in some applications, rather unnatural. When adding in any amount of data entry over the phone, it quickly becomes an impractical interface. Voice technologies, on the other hand, take advantage of the very interface that phones were designed to serve, and are undoubtedly accepted more readily by the general public. One alternative to the textual interface offered by technologies such as WAP or SMS is what was originally known as an IVR, or Interactive Voice Response, system. Historically, these systems have been very proprietary and therefore unsuitable for allowing access to Web-based content. That has completely changed with the advent of VoiceXML technology. VoiceXML is a markup language for creating voice-user interfaces. It uses speech recognition and/or touchtone (DTMF keypad) for input, and pre-recorded audio and text-to-speech synthesis (TTS) for output. It is based on the Worldwide Web Consortium's Extensible Markup Language (XML), and leverages the web paradigm for application development and deployment. Instead of using a PC with a Web browser, any telephone can access VoiceXML applications via a VoiceXML “interpreter” (also known as a “browser”) running on a telephony server. Whereas HTML is commonly used for creating graphical Web applications, VoiceXML can be used for voice-enabled Web applications. VoiceXML (also referred as VXML), development is similar to web development. Any web server can serve VoiceXML applications via HTTP to a voice portal. The voice portal renders the VoiceXML as an audible interactive voice application. Like HTML web pages, VoiceXML pages can be static or generated dynamically. Voice portals can be hosted or located at a customer premise. VoiceXML basically allows the definition of a “tree” that steps the user through a selection process—known as voice dialogs. The user interacts with these voice dialogs through the oldest interface known to mankind: the voice! Powerful speech recognition software resides on the server to convert the user's stated selection (e.g. “Yes” or “No”) into textual selection. This process is akin to selecting a hyperlink on a traditional Web page. Dialog selections result in the playback of audio response files (either prerecorded or dynamically generated using some sort of server-side text-to-speech conversion). The fact that VXML applications can be integrated with traditional Web services and accessible via a public phone number in a matter of hours makes this technology a must-support for solution providers looking to reach a large number of mobile users.

### BRIEF SUMMARY OF THE INVENTION

The present invention provides a system and method for instant match between people and business entities with reciprocal interests based on location, presence, and preferences.

In order to circumvent the limitations of current solutions, it is an object of the invention to provide a plurality of location based real-time connect and match services covering business and lifestyle issues above and beyond the usual realm of dating and chat. Another object of the invention is to ensure seamless transfer of information between disparate network and end-user devices using the service. A further object of the invention is to provide backward compatibility to legacy cell phones and other end-user devices with limited display and messaging capabilities. Yet another object of the invention is to empower people with visual impairment to enjoy the benefits of this service through speech-enabled applications that do not require any textual or graphical user interface. Furthermore, it is an object of the invention to facilitate a better likelihood of a match from a larger pool of users by operating over a greater distance without requiring line-of-sight or close proximity. It is a further object of the invention to operate in a peer-to-peer environment when network resources are not available for client-server based communication. In addition, it is an object of the invention to facilitate the creation of a commoditized market for Wi-Fi devices driven by the potential for mass consumer adoption of a new breed of services. It is also an object of the invention is to facilitate a new source of revenue for the Wireless Internet Service Provider (WISP) industry beyond basic Internet connectivity model.

The aforementioned objects as well as further and other objects and advantages of the invention are achieved by the presently preferred embodiment of the invention described herein below.

The system and method of the presently preferred embodiment of the invention have several features, no single one of which is solely responsible for its desirable attributes. Without limiting the scope of this invention as expressed by the claims that follow, its more prominent features will now be described briefly. After considering this discussion, and particularly after reading the section entitled “DETAILED DESCRIPTION OF THE INVENTION”, one will understand how the features of this invention provide several advantages over traditional matchmaking systems.

The presently preferred embodiment of the invention provides, in a communication network between a plurality of host computers and a plurality of communication devices, or between a plurality of communication devices in a peer-to-peer network, a system and method for transmitting and processing information about location, presence and profile of a plurality of people and business entities in a plurality of areas of application. The system and method are implemented in part by software applications that run on host computers, referred to herein as “iMatch Application Servers” and “iMatch Voice Portal”, and on commercially available portable communications devices, including but not limited to, Personal Digital Assistants (such as, PocketPC, Palm, BlackBerry etc.), Laptops, Tablet PC and other handheld devices with computation and communication capability.

The presently preferred embodiment of the invention can be used in a plurality of locations to address the specific needs of people representing a plurality of demographics. It should be understood, however, that there is no intent to limit the invention to the particular forms disclosed, but on the contrary, the intention is to cover all modifications, equivalents, and alternatives falling within the spirit and scope of the invention. This includes all areas of application where real-time location based matching would be useful or beneficial. In one of the areas of application of the presently preferred embodiment of the invention, referred to herein as “Dating”, the system and method provide a means to its users to match with their desired companion for romance, friendship or casual encounter. A preferred location for using this application is an iMatch Service Zone (explained later) that covers a plurality of nightclubs, even though the invention is not limited to the preferred location only and can be used in other locations too. In another area of application of the presently preferred embodiment of the invention, referred to herein as “Business”, the system and method provide a means to its users to match with other people with similar professional background and interest. A preferred location for using this application is an iMatch Service Zone (explained later) that covers a plurality of convention centers, even though the invention is not limited to the preferred location only and can be used in other locations too. In yet another area of application of the presently preferred embodiment of the invention, referred to herein as “Shopping”, the system and method provide a means to its users to match buyers with sellers in a retail environment. One aspect of the embodiment is that wherein retailers advertise their merchandise to prospective buyers within an iMatch Service Zone, and a match is made when the buyer's interest for a specific brand, price range or other criteria resembles the inventory in the store. A preferred location for using this application is an iMatch Service Zone (explained later) that covers a plurality of shopping malls and plazas, even though the invention is not limited to the preferred location only and can be used in other locations too. In still another area of application of the presently preferred embodiment of the invention, referred to herein as “Transaction”, the system and method provide a means to its users for transacting tickets and connecting with people seeking company in events. A preferred location for using this application is an iMatch Service Zone (explained later) that covers a plurality of theaters and sports complexes, even though the invention is not limited to the preferred location only and can be used in other locations too. In another area of application of the presently preferred embodiment of the invention, referred to herein as “Auction”, the system and method provide a means to its users to put “virtual instant classifieds” for any item they want to buy or sell, and a match is made when potential buyers and sellers come within an iMatch Service Zone and detect the presence of one another. This application is similar to the Shopping application with two important differences. First, unlike the Shopping application where the role of the buyer and seller is well, defined and the users have to follow that structure, the Auction application allows any user to be a buyer or seller depending on their preference. Second, unlike the shopping application where the location of the seller is fixed, the auction application allows sellers to roam freely and conduct their transaction in any iMatch Service Zone. This application can be used in any iMatch Service Zone with the same amount of perceived benefit. In yet another area of application of the presently preferred embodiment of the invention, referred to herein as “Leisure”, the system and method provide a means to its users to match with their desired companions for sports or other activities of common interest. A preferred location for using this application is an iMatch Service Zone (explained later) that covers a plurality of hotels, country clubs, resorts, casinos and the like where hospitality services are provided, even though the invention is not limited to the preferred location only and can be used in other locations too. In still another area of application of the presently preferred embodiment of the invention, referred to herein as “Association”, the system and method provide a means to its users to match with their desired companions sharing common religious, social, political, economical, scientific, or philosophical beliefs. This application can be used in any iMatch Service Zone with the same amount of perceived benefit.

In accordance with presently preferred embodiment of the invention, the iMatch Application Servers implement an enrollment process for allowing individuals and business entities to register as participants in the system. The enrollment process is implemented in part by Web pages that are transmitted to the computer of the individual or business entity, and by enrollment software application that runs on one or more of the iMatch Application Servers, referred to herein as “Enrollment Server”. During the enrollment process, the users select a set of attributes through a Web page for desired match with other individuals or business entities located within a user selectable search distance from the locations where the service can be provided. These locations, referred to herein as “iMatch Service Zone”, includes but not limited to a plurality of Public Wireless LAN Hot Spots, Public and Private Wireless LANs located in business centers and in people's homes, Cellular phone coverage areas from a multitude of carriers, and any other location that has direct access to Public Switch Telephony Network (PSTN), Public Land Mobile Network (PLMN) or any other network that uses Internet Protocol (IP). The said attributes, referred to herein as “Profile”, includes a combination of users' own personal characteristics, the characteristics of their desired match, and a numerical value assigned to each characteristics to weigh their relative importance. After selection, the profiles are downloaded to the users' portable communications devices and are ready to be used in all iMatch Service Zones. In addition, the profiles are also stored in a database associated with the iMatch Application Servers, referred to herein as “User Database”.

In accordance with presently preferred embodiment of the invention, the iMatch Application Servers implement a match process for matching people and business entities with reciprocal interests in the location of their presence in real-time. This match process is implemented by match software application that runs on one or more of the iMatch Application Servers, referred to herein as “Match Server”. When the Match Server receives a match request, it makes a list of possible entities that could be matched with the requester based on its knowledge about the profiles of other present and active users located within a specific distance from a specific iMatch Service Zone the user is interested to search. Then, with the permission of the parties involved, it sets up a communication session via one or more servers, referred to herein as “Communication Server”. The mode of communication depends on the ability of the devices, and can be one or more of the following: Text Message (native IM, native SMS, IM over SMS, and SMS over IM), Multimedia Message (MMS), Phone Call (VoIP or voice over circuit switch), and Email.

In accordance with presently preferred embodiment of the invention, a process is implemented for the users of portable communication devices to contact other users, either via the iMatch Application Server or directly in a peer-to-peer network, for a plurality of purposes, including but not limited to finding matches, responding to matched entities, editing profiles, and finding Public Hot Spots in a nearby location. This process is implemented by a plurality of device-specific application software, referred to herein as “iMatch Client”, that runs on a plurality of commercially available portable communications devices, including but not limited to, Personal Digital Assistants (PDA), Laptops, Tablet PC and other handheld devices with communication capability through a plurality of methods, including but not limited to 802.11 a/b/g WLAN, Bluetooth, UWB, and Ethernet-over-Infrared. When a Wi-Fi user within an iMatch Service Zone wants to communicate with other users, the iMatch Client first tries to connect with the nearest available access point to establish a session through the WLAN and an IP network outside of the zone. If the network is not available or the user is not authorized to use the WLAN for a variety of reasons including a lack of cross-roaming agreement between his/her WISP and the provider in that iMatch Service Zone, the iMatch Client automatically switches to an ad-hoc mode and allows the user to contact other users who are accessible in a peer-to-peer mode. The iMatch client contains a beacon/locator for identifying other iMatch users, a normalized user profile template for quick matching to other iMatch users and a peer-to-peer messaging and VoIP client for communications. When the iMatch client is running on the portable device, it periodically broadcasts an iMatch ping with its user ID indicating its presence and listens for the presence of other iMatch clients. When two or more iMatch clients are present within a 10,000 to 15,000 sq ft area, they create an ad-hoc Wi-Fi network and the area becomes an active iMatch zone. Each iMatch client in the zone then queries the other clients for their profile template. The profile template is normalized to allow for a rapid match calculation between two profiles to produce a weighted value indicating the quality of match. When the client finds a match between itself and another users profile in the zone the user can initiate a request for a messaging or voice session. When acknowledged by the other user, a peer-to-peer instant messaging or VoIP session is established between the two users. When there is only one user left present in the iMatch zone the ad-hoc Wi-Fi network ceases to exist.

This scenario is a true peer-to-peer application that does not require a network infrastructure to operate and does not require the user to subscribe to a Wi-Fi network service to use the iMatch service. It also provides the lowest operating cost when rolled out. Since the Wi-Fi device may not have a connection to the iMatch server when operating in an iMatch zone, profile changes can only be done from their home PC or other online terminal. The iMatch client contains a timed activation code, which allows its use to expire when a users subscription to the iMatch service expires.

In accordance with presently preferred embodiment of the invention, an Interactive Voice Response (IVR) process is implemented for the telephone users to contact other users via the iMatch Application Servers, for a plurality of purposes, including but not limited to finding matches, responding to matched entities, editing profiles, and activating or deactivating the match processes. The IVR process is implemented by a software application that runs on one or more of host computers, referred to herein as “iMatch Voice Portal”. The telephones can be of different vintage, including but not limited to, cell phones (with or without messaging and display capabilities), legacy wireline phones and IP Videophones with advance messaging and display capabilities. With voice being the only common denominator, these devices all use the same voice based user interface of the IVR application to access the iMatch Application Server. When the telephone users within an iMatch Service Zone want to communicate with one another, they make circuit switched phone calls over PSTN or VoIP calls over IP network to the iMatch Voice Portal and request information using voice or touchtone keys. Using a VXML interpreter, the IVR application sends the requests to the iMatch Application Servers via HTTP and translates the responses to audio output that are either pre-recorded or computer-synthesized through a Text-to-Speech (TTS) conversion program. This allows the telephone users to access the same information in the iMatch Application Servers that is available to other users through data network. Once a match is made, a plurality of other communication methods, including but not limited to, text messaging (SMS, SMS over IM), multimedia messaging (MMS), and Email (native client, WAP based, or i-Mode based), are used for contacting the users with portable communication devices or telephone. These methods of communication are implemented by a plurality of software applications that run on one or more of the iMatch Application Servers, referred to herein as “Communication Server”.

### BRIEF DESCRIPTION OF THE DRAWINGS

These and other aspects of the presently preferred embodiment of the invention may best be understood with reference to the drawings of certain preferred embodiments, which are intended to illustrate and not to limit the invention, and in which:

FIG. 1 shows a simplified schematic block diagram of the system constructed in a preferred embodiment of the present invention, wherein the users with various communication devices can access the application and services of the invention

FIG. 2 is a more detailed architectural drawing showing the main functional elements of the system that operates in a preferred embodiment of the present invention.

FIG. 3 is a simplified schematic block diagram showing the various servers of the system in a preferred embodiment of the present invention.

FIG. 4 is a simplified schematic block diagram showing the main functional components of one or more software applications residing in portable communication devices in a preferred embodiment of the present invention.

FIG. 5 is a simplified schematic block diagram showing the main functional components of one or more software applications residing in the B2C Transaction server in a preferred embodiment of the present invention.

FIGS. 6A-6C are simplified schematic block diagrams showing the main functional components of one or more software applications residing in the Voice Portal, the Communication server, and the B2B Transaction server in a preferred embodiment of the present invention.

FIGS. 7A and 7B together depict a flowchart illustrating a process of communication and data transaction employed by one or more software applications residing in portable communication devices in a preferred embodiment of the present invention.

FIG. 8 is a flowchart illustrating a process of user enrollment employed by one or more software applications residing in the Enrollment server of the system in a preferred embodiment of the present invention.

FIG. 9 is a flowchart illustrating a process of user match employed by one or more software applications residing in the Match server of the system in a preferred embodiment of the present invention.

FIGS. 10A and 10B together depict a flowchart illustrating a process of Interactive Voice Response (IVR) based communication and data transaction employed by one or more software applications residing in the Voice Portal of the system in a preferred embodiment of the present invention.

In the drawings, the first digit of each reference number indicates the Figure number in which the referenced item first appears.

### DETAILED DESCRIPTION OF THE INVENTION

The following detailed description is directed to certain specific embodiments of the invention. However, the invention can be embodied in a multitude of different ways as defined and covered by the claims. In this description, reference is made to the drawings wherein like parts are designated with like numerals throughout.

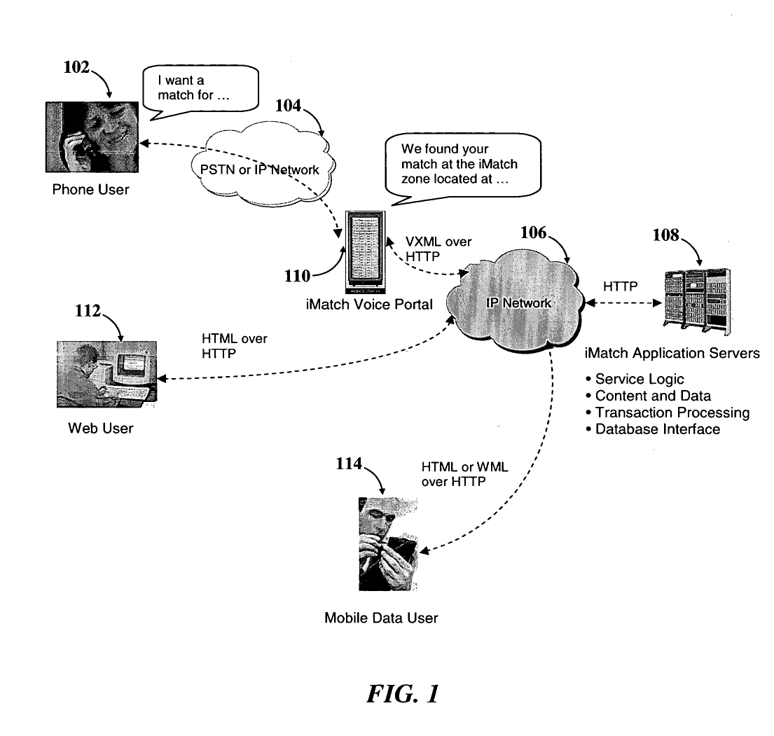

FIG. 1 shows a simplified schematic block diagram of the system constructed in a preferred embodiment of the present invention, wherein the users with various communication devices can access the application and services of the invention. In operation, a user 112 first selects a “Profile” for a desired match with an individual or business entity with reciprocal interest. This is done through a web based enrollment application running on one or more of the iMatch Application Servers 108, referred to herein as “Enrollment Server”. The selected “Profile” and a device specific client application is then downloaded on their Wi-Fi compliant PDA (or other portable communications device) through an IP network 106, such as the Internet. Upon entering an “iMatch Service Zone”, a mobile data user 114 uses the client application on their Wi-Fi compliant PDA (or other portable communications device) to broadcast their presence to the nearest wireless access point, which in turn sends the data to on one or more of the iMatch Application Servers 108 running the matching algorithms. If the WLAN is not available, the client application automatically switches to an ad-hoc mode and allows the user to contact other users who are accessible in a peer-to-peer mode within a certain distance. When a telephone user 102 within an iMatch Service Zone wants to communicate with other users, he/she makes a phone call to the iMatch Voice Portal 110 running an Interactive Voice Response (IVR) based application. The user 102 requests information using voice or touchtone keys. Using a VXML interpreter, the IVR application sends the requests to the iMatch Application Servers 108 via HTTP and translates the responses to audio output that are either pre-recorded or computer-synthesized through a Text-to-Speech (TTS) conversion program. The iMatch Application Servers 108, with full knowledge about other present and active users located within a specific distance from a specific iMatch Service Zone the user (102 or 114 or 112) is interested to search, makes an initial assessment about the likelihood of a match. Then, with the permission of the parties involved, it sets up a communication session in the form of Text Message (native IM, native SMS, IM over SMS, and SMS over IM), Multimedia Message (MMS), Phone Call (VoIP or voice over circuit switch), or Email. Using Business-to-Business (B2B) integration at the server level, additional value-added services are provided in this system for a variety of purposes. This includes, but not limited to: background check, credit card transaction, mapping and navigation, retail directory services. targeted advertisement, Public Hot Spot listing, live entertainment through webcast portal or TV tuners, and contact data import for professional networking.

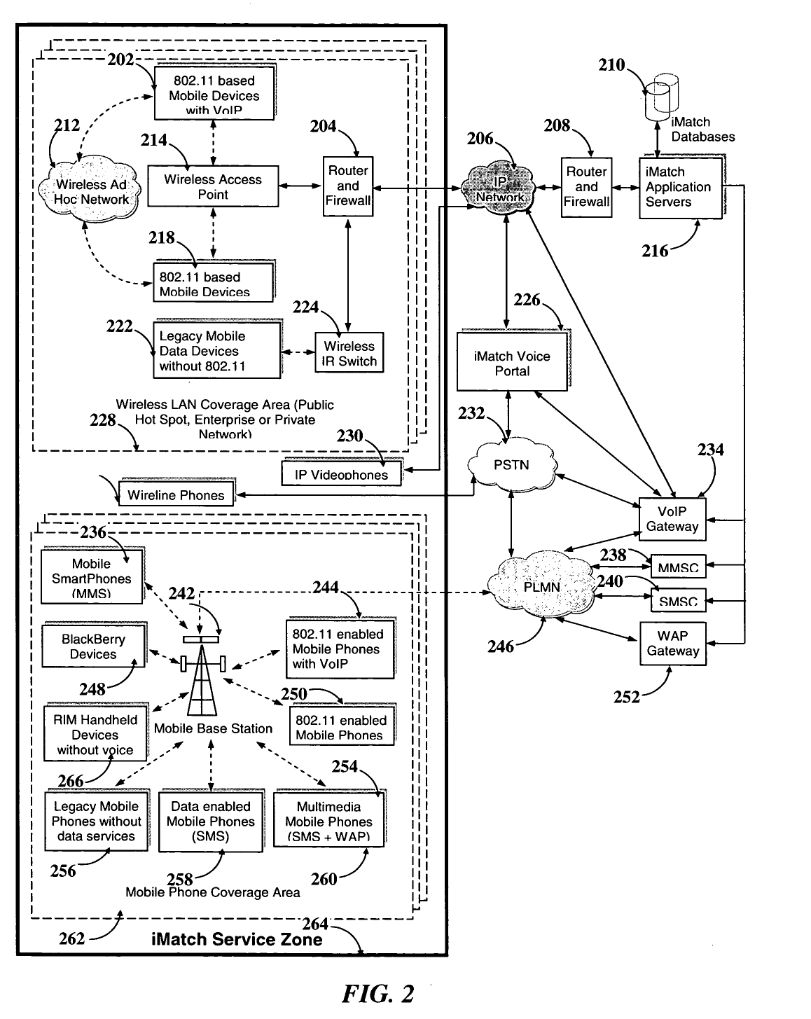

FIG. 2 is a more detailed architectural drawing showing the main functional elements of the system that operates in a preferred embodiment of the present invention. The system comprises a plurality of portable communications devices, cell phones and legacy wireline phones of different vintage operating within iMatch Service Zone 264, which includes but not limited to a plurality of Wireless LANs 228, Cellular phone coverage areas 262, and any other location that has direct access to Public Switch Telephony Network (PSTN) 232, Public Land Mobile Network (PLMN) 246 or any IP network 206. The users of the aforementioned devices communicate with one another via the iMatch Application Servers 216 and the iMatch Voice Portal 226, both of which run on a multitude of host computers and make use of several associated databases 210 containing user information and other system related data. The exception to this mode of client-server communication occurs when the Wireless LAN 228 becomes unavailable and the client application on the portable communications devices automatically switches to an Wi-Fi ad-hoc mode and allows the users to contact one another in a peer-to-peer (P2P) mode over a wireless ad-hoc network 212. Depending on the communication capability of the devices, the users can employ a variety of methods to contact one another. In this system, some of the portable communications devices 218 have 802.11 base WLAN client for data applications, some devices 202 also have the capability to make phone calls via VoIP applications that can run over WLAN. These Wi-Fi devices use wireless access point 214 and router and firewall 204 to get access to IP network 206 connected to the iMatch Application Servers 216. Some legacy devices 222 do not have any Wi-Fi client, and therefore cannot access the network through an wireless access point 214. But all portable communications devices have Infrared (IR) ports, which can be connected to an wireless IR switch 224 that provides communication via Ethernet-over-IR and can access the IP network 206 through router and firewall 204. This architecture ensures that all devices can participate in this system with varying degrees of communication capability. They all require device specific clients, referred to herein as “iMatch Client”, to function properly according to their specific hardware and operating systems. The “iMatch Client” can be downloaded from the iMatch Application Servers 216 at the time of enrollment (explained later). It should be understood that the list of aforementioned portable communications devices is provided only as an example, the invention can be embodied in a multitude of different ways using other devices.

In an iMatch Service Zone, several mobile devices can operate via Public Land Mobile Network (PLMN) 246. Some of these mobile devices, known as SmartPhones 236, have advanced multimedia capability through MMS, in addition to the basic voice features. Some mobile phones 258 have text messaging capability through SMS, still others 260 have WAP or i-Mode based web browsers for Internet access. Legacy mobile phones 256 usually do not have data capabilities. Some recent mobile phones can operate in dual mode, making it possible to communicate in both PLMN and 802.11 WLAN. The WLAN capability of these phones can either be for data applications only 250, or for data and voice (VOIP over WLAN) both 244. Different types of BlackBerry devices 248 with data and voice capabilities, as well as RIM Handheld devices 266 with no voice capability can also be present in this system. It should be understood that the list of aforementioned devices running over PLMN is provided only as an example, the invention can be embodied in a multitude of different ways using other devices.

In an iMatch Service Zone, land-based phones may also be present. This includes legacy wireline phones 220 using PSTN 232, and IP Videophones 230 using IP network 206. It should be understood that the list of aforementioned , land-based phones is provided only as an example, the invention can be embodied in a multitude of different ways using other devices.

In operation, when a telephone user within an iMatch Service Zone wants to match with another user who uses a WLAN or a PSTN or PLMN, the telephone user first makes circuit switched phone calls over PSTN/PLMN or VoIP calls over IP network to the iMatch Voice Portal, and request information using voice or touchtone keys. Using a VXML interpreter, the IVR application sends the requests to the iMatch Application Servers via HTTP and translates the responses to audio output that are either pre-recorded or computer-synthesized through a Text-to-Speech (TTS) conversion program. This allows the telephone users to access the same information in the iMatch Application Servers that is available to other users through data network. Once a match is made, a plurality of other communication methods, including but not limited to, text messaging (SMS, SMS over IM), multimedia messaging (MMS), and Email (native client, WAP based, or i-Mode based), are used for contacting the users with portable communication devices or telephone. These methods of communication are implemented by a plurality of software applications that run on one or more of the iMatch Application Servers, referred to herein as “Communication Server”. If both the sender and the recipient have MMS capabilities on their phones and they choose to see their images stored on the iMatch Application Servers 108 as part of their profile, the Communication Server through its MMS/WAP gateway interface 626, sends the image to a Multimedia Messaging Service Center (MMSC) 238, from where they are routed to the recipient. If the receiving terminal is identified as a non-MMS phone, then the message is stored on a web page instead of being sent to the phone. An SMS is then sent to the non-MMS phone with the address to the web page where the message can be retrieved. If both parties only have SMS capabilities, the Communication Server through its Text Message Bridge 618, sets up a connection to a Short Message Service Centre (SMSC) 240, from where the text message is routed to the recipient. If both the sender and the recipient have text messaging capability, but one uses Instant Messaging (typically a PDA user) and the other uses SMS (typically a cell phone user), then the Text Message Bridge 618 sets up a connection between an IM client and a cell phones text interface so that they can exchange text messages. If the matched parties prefer voice communication, they have the choice to do that over PSTN or PLMN (without any assistance from the Communication Server) or a VoIP call is set up by the Communication Server allowing the parties to communicate without disclosing their phone numbers. For VoIP, a call is established to each user through a third party gateway providers' VoIP gateway 234, and then the call is redirected to each one of them.

In operation, when a user of a portable communications device a within an iMatch Service Zone wants to contact another user who uses a WLAN or a PSTN or PLMN, the portable communications device user can use a VoIP phone call over WLAN 228 and VoIP gateway 234, provided the recipient's device has voice capability. If one of the parties has only data capability, the choice of communication is between IM, IM over SMS, or Email.

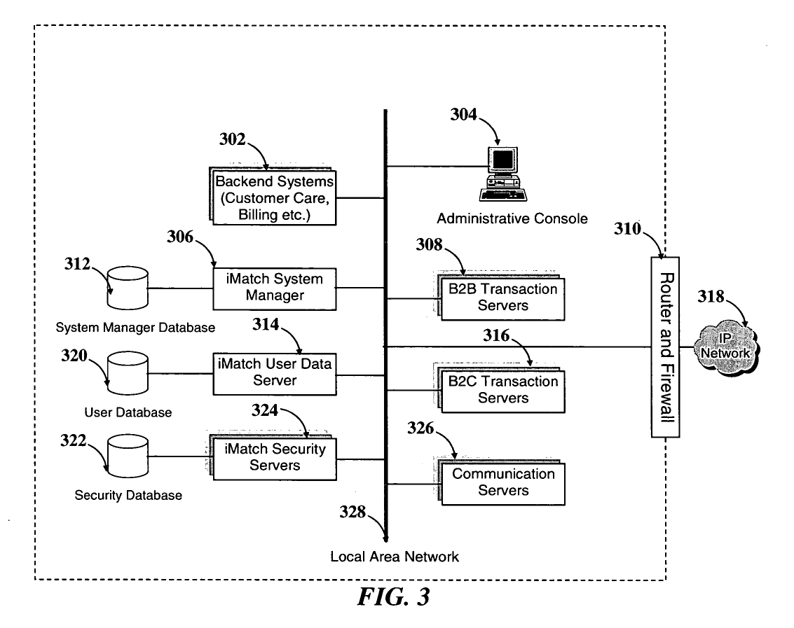

FIG. 3 is a simplified schematic block diagram showing the various servers of the system in a preferred embodiment of the present invention. As indicated earlier, these servers are collectively referred herein as iMatch Application Servers. Each of these servers interfaces with other systems in this architecture using Internet-standard protocols to transmit data and to exchange control information. It should be understood that the servers are logical units, and do not necessarily correspond to the number of physical workstations that are deployed. For a small deployment or for proof-of-concept, they can be consolidated in a single computer. For a full, scaled-up deployment, a server may be instanced on many computers spread across a number of networks and/or locations. The functionality of theses servers is as follows.

Backend Systems 302 are used for customer care, billing, and various ERP and CRM systems. They can be provided by 3^{rd} party vendors. They have web based administrative interface, and provide various customized billing and technical reports. The iMatch System Manager 306 and the associated System Manager Database 312 provide centralized configuration management for all iMatch servers. All other servers receive configuration information from the iMatch System Manager 306. In accordance with a presently preferred embodiment of the invention, this configuration information is described in XML and is transmitted over HTTP. In a presently preferred embodiment of the invention, the System Manager communicates with Backend Systems 302 using IIOP and with the Administrative Console 304 using SNMP. Systems Administrators monitor and change server configuration settings from the System Manager's console application. This is a web-based application that can be run from any browser that has access to the iMatch System Manager 306. The iMatch User Data Server 314 and the associated User Database 320 provide storage for user preferences, account information, communication device information and standard Internet cookies. In a presently preferred embodiment of the invention, the iMatch User Data Server 314 communicates with the System Manager using XML over HTTP, and with the Administrative Console 304 using SNMP. In a presently preferred embodiment of the invention, information in the User Data database are shared with other authorized systems (e.g., Billing Systems) using IIOP. The iMatch Security Servers 324 comprise three different servers. The first server is an Authentication, Authorization and Accounting (AAA) server used for the purpose of authentication (verifying identity), authorization (verifying access rights to a multitude of system resources) and accounting (monitoring the usage of network and system resources) of users. In a presently preferred embodiment of the invention, the AAA server can be a RADIUS or DIAMETER based server. The second server is a Key List Server that is used for generation, archival and distribution of encryption keys used in certain message exchanges between the devices and the iMatch Application server. The third server is a TLS/SSL gateway that is used for conducting secure transactions using HTTPS. The associated Security Database 322 stores data related to the three servers that are part of the Security Server system. The Administrative Console 304 uses SNMP to communicate with all other iMatch servers. In a preferred embodiment of the invention, standard SNMP based network management tools, such as HP OpenView or IBM Tivoli, can be used to monitor fault and performance of the servers, and to shut down and start them remotely from a centrally administered operator console. The B2B Transaction Servers 316 are used to exchange information with various Business-to-Business (B2B) service providers for a variety of functions. This includes, but not limited to: background check, credit card transaction, mapping and navigation, retail directory services. targeted advertisement, Public Hot Spot listing, live entertainment through webcast portal or TV tuners, and contact data import for professional networking. The B2C Transaction Servers 316 comprise three different servers. The first server is the Enrollment Server, used for the registration of user profiles in the target areas of application and for managing the device IDs. The second server is the Match Server, used for matching users in the target areas of application. The thirds server is the Media server, used for distribution of targeted banner and pop-up ads to the mobile data users and speech-based ads to the phone users. Communication Servers 326 facilitates various forms of communication. They have interfaces for Text Messaging, MMS/WAP Gateway, VoIP Gateway, and Email Servers.

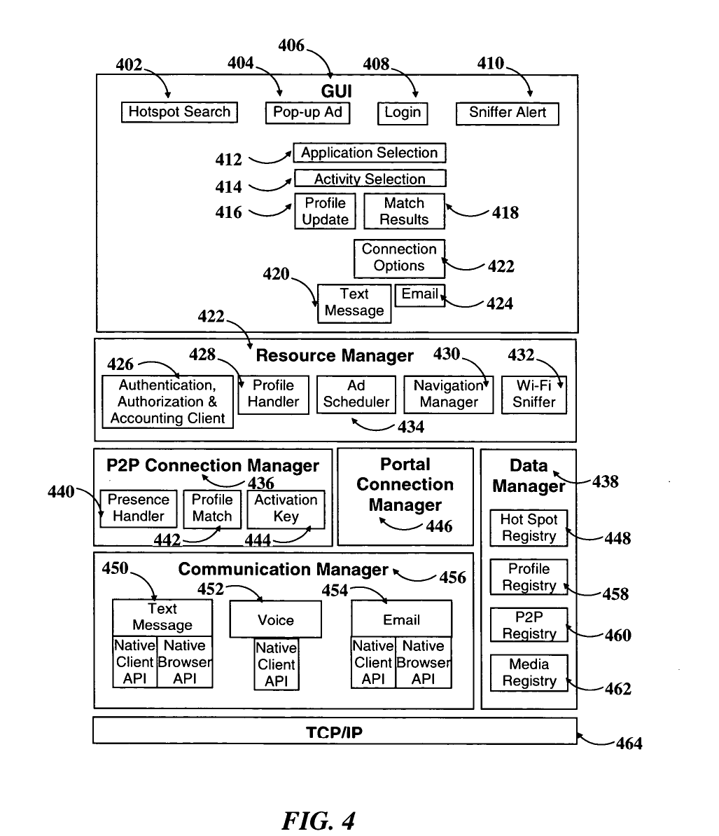

FIG. 4 is a simplified schematic block diagram showing the main functional components of one or more software applications residing in portable communication devices in a preferred embodiment of the present invention. The iMatch Client has several layers of software applications that run over TCP/IP protocol stack 464. At the top layer is a Graphical User Interface (GUI), in which the user logs in through a Login screen 408, which with the help of a AAA client 426 in the Resource Manager layer underneath, communicates with the AAA server to facilitate the login process of the user. If the login is successful, the user is presented with a Application Selection screen 412, which allows the user to select among various possible areas of application (e.g., Dating, Business etc.) for which the user is authorized to. The authorization information comes from the AAA server. Upon selecting an application, the user is presented with an Activity Selection screen 414 , which gives a selection of activities in the chosen area of application (e.g., finding match, responding to match, editing profile etc.). If the user selects the option of finding match, he/she is either connected to the Match Server through the Portal Connection manager 446, or if the network is not available, the P2P Connection Manager 436 conducts a local search in the ad-hoc mode with the help of profile data stored in Profile Registry 458, a lightweight version of Match Server contained in Profile Match 442 module and lightweight version of Presence Manager 540 contained in Presence handler 440 module. In both the cases, the match results are presented in the Match Results screen 418. If instead of match, the user chooses to change his/her profile through the Profile Update screen 416, Profile Handler 428 contacts the Profile Manager 508, a component within the Enrollment Server, to make such updates. After the Match Results screen 418, the user is given a choice of various modes of communication in the Connections Options screen 422. If Text Message 420 option is chosen, the Text message component 450 of the Communications Manager 456 establishes the session either through a native client (e.g. an IM client) API or through a browser API (when no native client is present on the device). If Email 424 option is chosen, the Email component 454 of the Communications Manager 456 establishes the session either through a native email client API or through a browser API (when no native client is present on the device). The Ad Scheduler 434 is a process that runs in the background and downloads the content of pop-up and other banner ads from the Content Manager (a component in the Media Server 548) to its local Media Registry 462. For those users who have agreed to receive pop-up ads, Ad Scheduler 434 delivers the ads at a pre-determined interval through the pop-up ad screen 404. The Wi-Fi sniffer 432 detects and communicates to the user (through the sniffer alert screen 410) whether or not a network is present in the vicinity and available for usage. Hot Spot Registry 448 is a remotely updated and searchable Hot Spot database so that mobile users can identify those locations even when they are offline. The Navigation Manager 430 aggregates information from the Hot Spot Registry 448 and Wi-Fi Sniffer 432 and presents it to the user through the Hot Spot Search screen 402. The Activation Key 444, generated by the Enrollment Server based on the MAC Address of the device provided by the AAA client, is delivered to the device on a regular basis as long as the user account is active. If the Activation Key 444 has expired and not been renewed, the user cannot use the device.

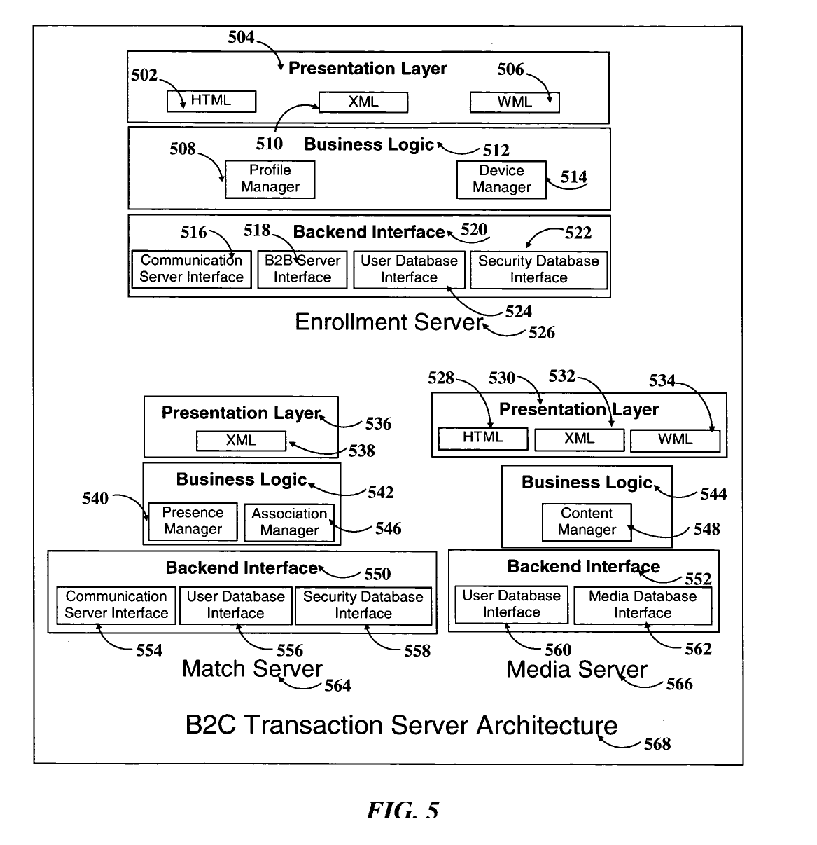

FIG. 5 is a simplified schematic block diagram showing the three main functional components of the B2C Transaction server in a preferred embodiment of the present invention.

The Enrollment Server 526, in its Presentation Layer 504, has an HTML based interface 502, an XML based interface 510, and a WML based interface 506. The HTML based interface 502 allows people to access the server through a regular web browser running on a desktop PC or laptop. The XML based interface 510 allows people to access the server through the iMatch Voice Portal with IVR system. The WML based interface 506 allows people to access the server through a lightweight WAP browser running on a mobile phone. The Business Logic 512 of the Enrollment Server has a Profile Manager 508, whose main task is to store user profile in the User Database and allow the authenticated users to update it whenever they want. The Business Logic of the Enrollment Server further has a Device manager 514, whose main task is to generate and store device ID and Activation key, and facilitate the software download for various device specific iMatch clients.

The Match Server 564, in its Presentation Layer 536, has a XML based interface 538 that allows people to access the server through the iMatch Voice Portal with IVR system. The Business Logic of the server has a Presence Manager 540, whose main task is to keep track of present and active users in iMatch Service Zones. The Business Logic of the server further has a Association Manager 546, whose main task is to run the matching algorithm to find possible matches between requesting users based on their profile.

The Media Server 566, in its Presentation Layer 530, has an HTML based interface 528, an XML based interface 532, and a WML based interface 534. The HTML based interface 528 allows people to access the server through a regular web browser running on a desktop PC or laptop. The XML based interface 532 allows people to access the server through the iMatch Voice Portal with IVR system. The WML based interface 534 allows people to access the server through a lightweight WAP browser running on a mobile phone. The Business Logic of the server has a Content Manager 548, whose main task is to get the contents of advertisements (audio and video) from the Media database Interface 562, and send them to the local Media Registry 462 in the iMatch client.

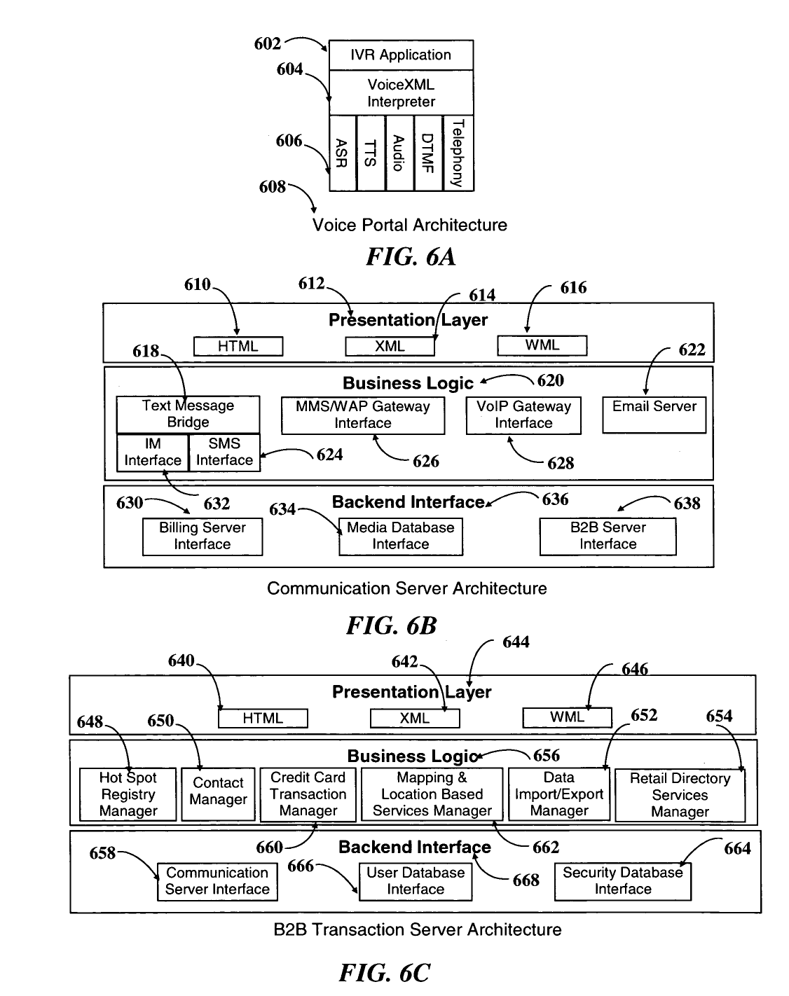

FIGS. 6A-6C are simplified schematic block diagrams showing the main functional components of one or more software applications residing in the Voice Portal, the Communication server, and the B2B Transaction server in a preferred embodiment of the present invention.

The voice portal has several lower level interfaces 606 for Automated Speech Recognition (ASR) engine, Text-to-Speech (TTS) conversion engine, Audio, DTMF and Telephony. The IVR application 602, built over the VXML interpreter, provides a similar functionality like the iMatch client through a voice interface.

The Communication Server, in its Presentation Layer 612, has an HTML based interface 610, an XML based interface 614, and a WML based interface 616. The HTML based interface 610 allows people to access the server through a regular web browser running on a desktop PC or laptop. The XML based interface 614 allows people to access the server through the iMatch Voice Portal with IVR system. The WML based interface 616 allows people to access the server through a lightweight WAP browser running on a mobile phone. The Business Logic has a Text Message Bridge 618, whose main function is to set up a connection to a to a Short Message Service Centre (SMSC) when communication is warranted through SMS on both sides. The Text Message Bridge 618 can also set up a connection between an IM client and a cell phones text interface so that they can text messages can be exchanged between an IM and SMS user. The Business Logic further has a MMS/WAP gateway interface 626, whose main function is to send images to a Multimedia Messaging Service Center (MMSC) 238, from where they are routed to MMS recipients. The Business Logic also has a VoIP gateway interface 628, whose main function is to establish call sessions through third party gateway providers' VoIP gateway 234, and then redirect the call to the requesting parties.

The B2B Server, in its Presentation Layer 644, has an HTML based interface 640, an XML based interface 642, and a WML based interface 646. The HTML based interface 640 allows people to access the server through a regular web browser running on a desktop PC or laptop. The XML based interface 642 allows people to access the server through the iMatch Voice Portal with IVR system. The WML based interface 646 allows people to access the server through a lightweight WAP browser running on a mobile phone. The B2B Server, in its Business Logic 656 has a Hot Spot Registry manager 648, whose main function is to interface with external systems that provide up to date information on the exact location of Hot Spots and then to deliver this information to the Hot Spot Registry 448 running locally on the devices as part of the iMatch client. The B2B Server, in its Business Logic 656 has a Contact manager 650, whose main function is to interface with external systems that provide information about people's contact info in various professions that are useful for business networking purposes. The B2B Server, in its Business Logic 656 has a Credit Card Transaction Manager 660, whose main function is to interface with external systems that take credit card information and conduct purchase and verification. The B2B Server, in its Business Logic 656 has a Mapping and Location Based Services Manager 656, whose main function is to interface with external systems that provide various LBS services such as point-of-interest (POI), event searching, location based advertisement, and, GPS assisted (or conventional) interactive mapping and navigation. The B2B Server, in its Business Logic 656 has a Data Import/Export Manager 652, whose main function is to interface with various other external systems to import data from and to export data to in a variety of formats. The B2B Server, in its Business Logic 656 has a Retail Directory Services Manager 654, whose main function is to provide an interface to retailers (subscribing to the Shopping Application) through the Presentation Layer (HTML, XML, WML) so that they can edit and update their inventory information through web browsers, IVR application or cell phone.

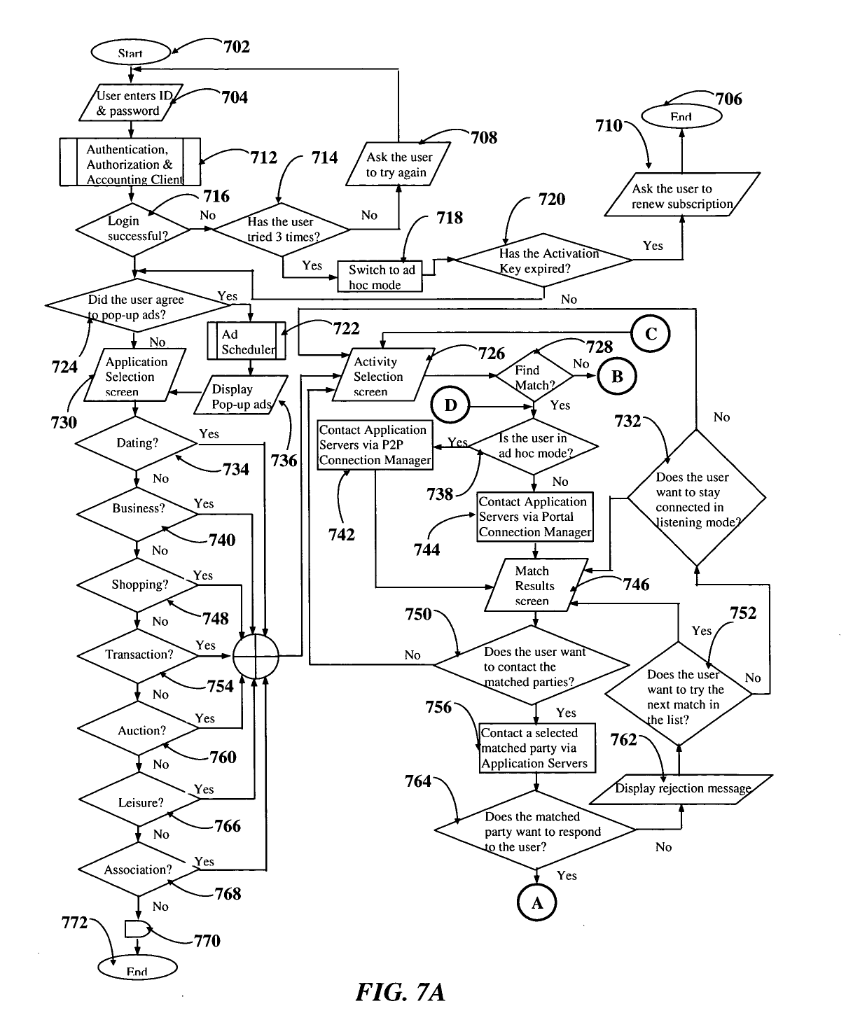

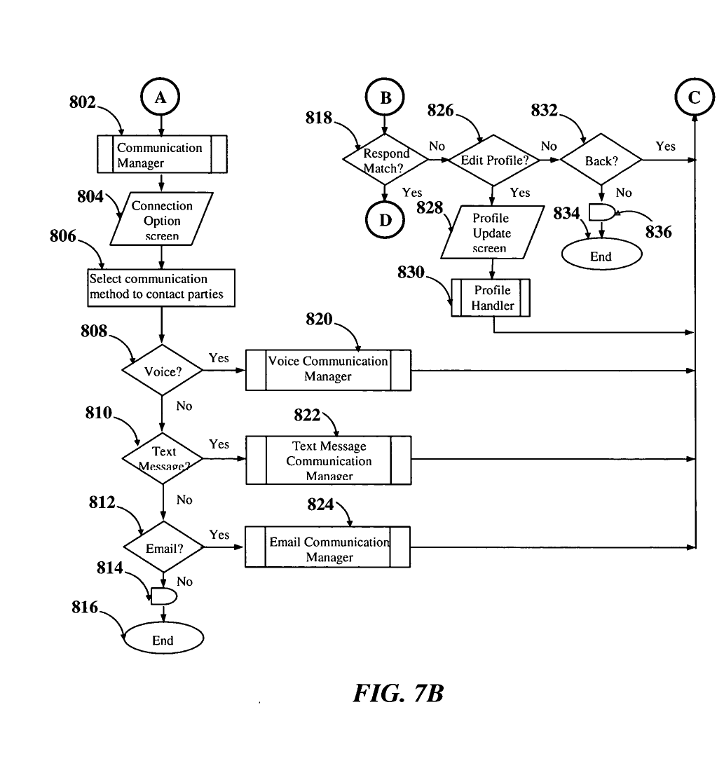

FIGS. 7A and 7B together depict a flowchart illustrating a process of communication and data transaction employed by one or more software applications residing in portable communication devices in a preferred embodiment of the present invention. It should be understood that, in order not to obscure the inventive features of the present invention, the following description of flow control is not an exhausting account of all the signals and control functions associated with the operation of the process. Thus a number of conventional operations and signals which are not essential for understanding the essence of the present invention are not depicted in the flowchart of FIGS. 7A and 7B since those signals and operations are well known to those of ordinary skill in the art. As depicted in FIGS. 7A and 7B, from a start block 702 control passes to an action block 704 where user enters user ID and passwords which is then sent by the AAA client 712 to the AAA server (not shown in flowchart). If the user's login is successful as determined in decision box 716, control passes to decision box 724 wherein it is determined if advertisements can be enabled for the user. If the ads can be enabled, then the Ad Scheduler process 722 plays specific ads to the user and then return control to the Appplication Selection screen 730. If the login was not successful in step 716, the process tries it to a maximum of three more times in steps 714 and 708 before deciding to switch to the ad hoc mode in step 718. The control then passes to decision box 720, wherein the process checks for the expiry of the activation key. If the key has expired, it prompts the user to renew the subscription 710 and terminates the process 706. If the activation key has not expired, the control passes to decision box 724 wherein it is determined if advertisements can be enabled for the user. The Appplication Selection screen 730 allows the selection of seven areas of application, in decision boxes 734, 740, 748, 754, 760, 766, and 768. If the user fails to make a selection, the process terminates in step 772 after a brief delay 770. If a selection is made in the Appplication Selection screen 730, control passes to Activity Selection Screen 726 that allows the selection of four activities in decision boxes 728, 818, 826 and 832. If “Find Match” is selected in 728, a determination is made in 738 whether or not the user is in ad hoc mode. For users not in ad hoc mode, communication is set up through Portal Connection Manager 744, whereas users in ad hoc mode are connected through P2P Connection Manager 742. In each case, the results are presented in the Match Results screen 746, from where a decision is made in 750 if the user wants to contact the matches. Users who are not interested for contact go back to the Activity Selection screen 726 where they can choose other activities. Users who are interested to make contact are led through the process in 756, and if the matched party is determined to be interested to respond 764, control passes to Communication Manager in 802, which then lets the user select a preferred way of contact through the Connection Option screen in 804. Depending on the choice made thereafter in decision boxes in 810, 812 or 812, communication starts through voice, text message or email in 820, 822, or 824. If the user fails to make a selection, the process terminates in step 816 after a brief delay 814. In step 764, if the matched party decides not to make a contact, the requesting user gets a rejection message in 762 after which he has a choice to either try the next match in the list in 752 or just stay connected for more results in 732 (which, in both cases, brings him back to the Match Results screen 746). If the user does not want to stay connected, it brings him back to the Activity Selection Screen in 726. If the user chooses to respond to the matches in 818 (before conducting his own search), the control passes to the decision box 738 wherein the same process starts as in the case of finding a match. If the user choose to edit profile in 826, the profile update screen allows him to do that with the help of profile handler in 830, and passes the control back to Activity Selection Screen when it is finished. Control is also brought back to the Activity Selection Screen when user explicitly wants to go back to the previous screen in step 832.

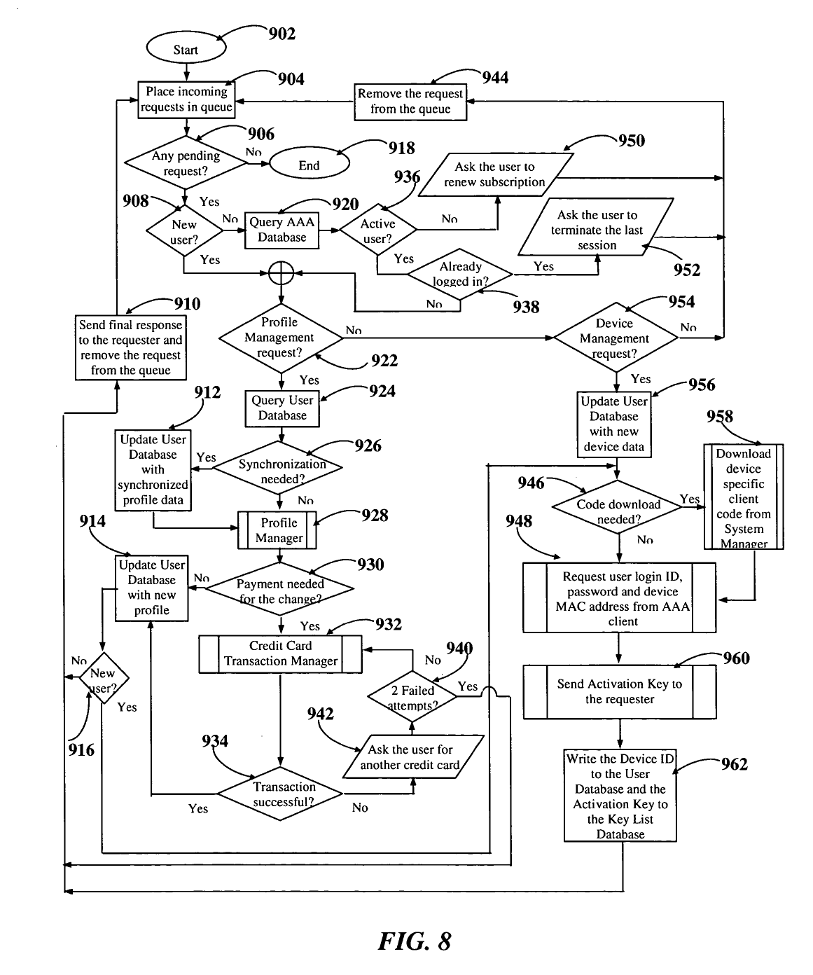

FIG. 8 is a flowchart illustrating a process of user enrollment employed by one or more software applications residing in the Enrollment server of the system in a preferred embodiment of the present invention. It should be understood that, in order not to obscure the inventive features of the present invention, the following description of flow control is not an exhausting account of all the signals and control functions associated with the operation of the process. Thus a number of conventional operations and signals which are not essential for understanding the essence of the present invention are not depicted in the flowchart of FIG. 8 since those signals and operations are well known to those of ordinary skill in the art. As depicted in FIG. 8, the server places all incoming requests in a queue 904 and does not terminate the process until all requests are served 906. Any incoming request that is determined to be either from a new user (in step 908) or an active user (in step 936) who is currently not logged in another session as determined by step 938, is passed to the second level where the process checks if it is a request for Profile Management 922 or Device Management 954. Requests for Profile Management are handled by querying the user database 924 that reveals whether or not the profile presented by the user matches with the data stored in the database, i.e. any synchronization needed or not 926. If they are different, which could happen for a number of reasons including if the user's last session was a P2P and the profile was changed during that time which was not updated in the user database, the database is updated with synchronized profile data 912. The Profile Manager than handles the requested change 928, and if the change requires payment (e.g., user upgrading their service), the Credit Card Transaction Manager handles the processing 932. The new profile is updated in the user database, and then for a new user enrolling for the first time (as determined in 916), the process further leads him through the rest of the enrollment where it is first checked if he needs a new code download for iMatch client 946 or not. If needed, the device specific code, based on the information provided by the user at the time of enrollment, is downloaded from the System Manager 958. The process then requests and obtain the user ID, password and MAC address of the device from the AAA client, and calculates a unique Activation Key and device ID for the user with that specific device MAC address. The device ID is used in subsequent sessions to ensure that the user's login information is not abused by other people to run the same service on multiple devices. A Device Management request, as determined in 954, can come from an existing user that needs a fresh software download or new device registration. The steps followed are the same as in case of a new user from the decision box 946.

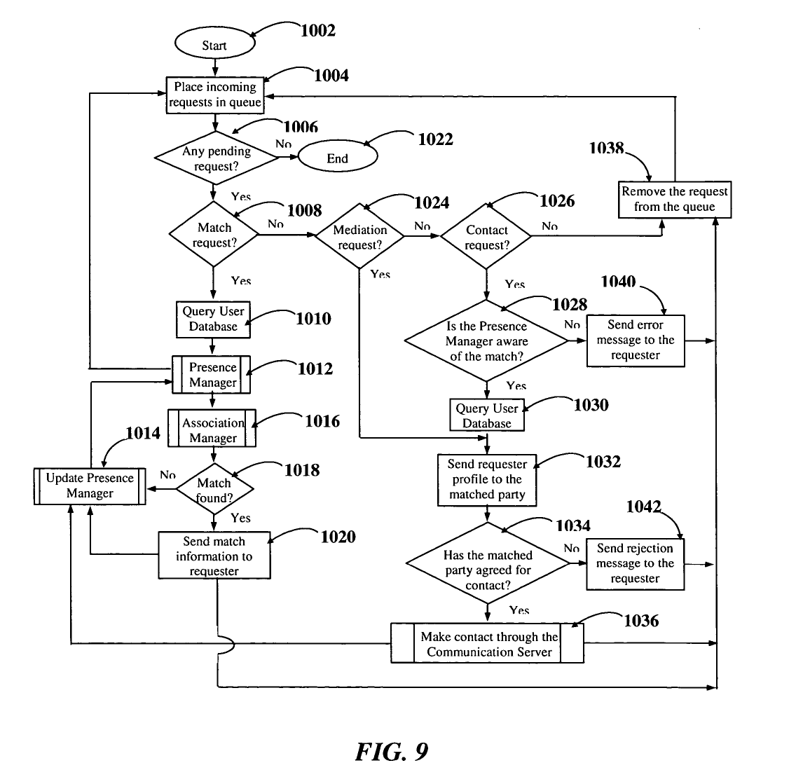

FIG. 9 is a flowchart illustrating a process of user match employed by one or more software applications residing in the Match server of the system in a preferred embodiment of the present invention. It should be understood that, in order not to obscure the inventive features of the present invention, the following description of flow control is not an exhausting account of all the signals and control functions associated with the operation of the process. Thus a number of conventional operations and signals which are not essential for understanding the essence of the present invention are not depicted in the flowchart of FIG. 9 since those signals and operations are well known to those of ordinary skill in the art. As depicted in FIG. 9, the server places all incoming requests in a queue 1004 and does not terminate the process until all requests are served 1006. If an incoming request is determined to be a match request 1008, the user database is queried to read the profile of the requesting user 1010, and then Presence Manager adds the user to active list 1012. The Association Manager runs the matching algorithm for the specific area of application requested, and if a matches are found in 1018, it sends the information to the requesting user 1020 and also updates the Presence Manager 1014. After that, it removes the request from the queue 1038. If an incoming request is determined to be a contact request 1026, i.e. a user explicitly seeking the contact info of another user from the Match Server, it is first checked if the Presence Manager is aware of the match the user is reporting 1028. Any unauthorized request for contact is rejected 1040. If it is a legitimate request, the user database is queried to read the profile of the requesting user 1030, and then the requester's profile is sent to the respondent 1032. If the respondent agrees to make contact 1034, a communication session is established via the communications manager 1036. Otherwise, a rejection message is sent 1040 and the request is removed from the queue 1038. If an incoming request is determined to be a mediation request 1024, which is internally generated by the Presence Manager based on its knowledge of active and present users in the location of search, the steps followed are the same as in case of a contact request since 1032.

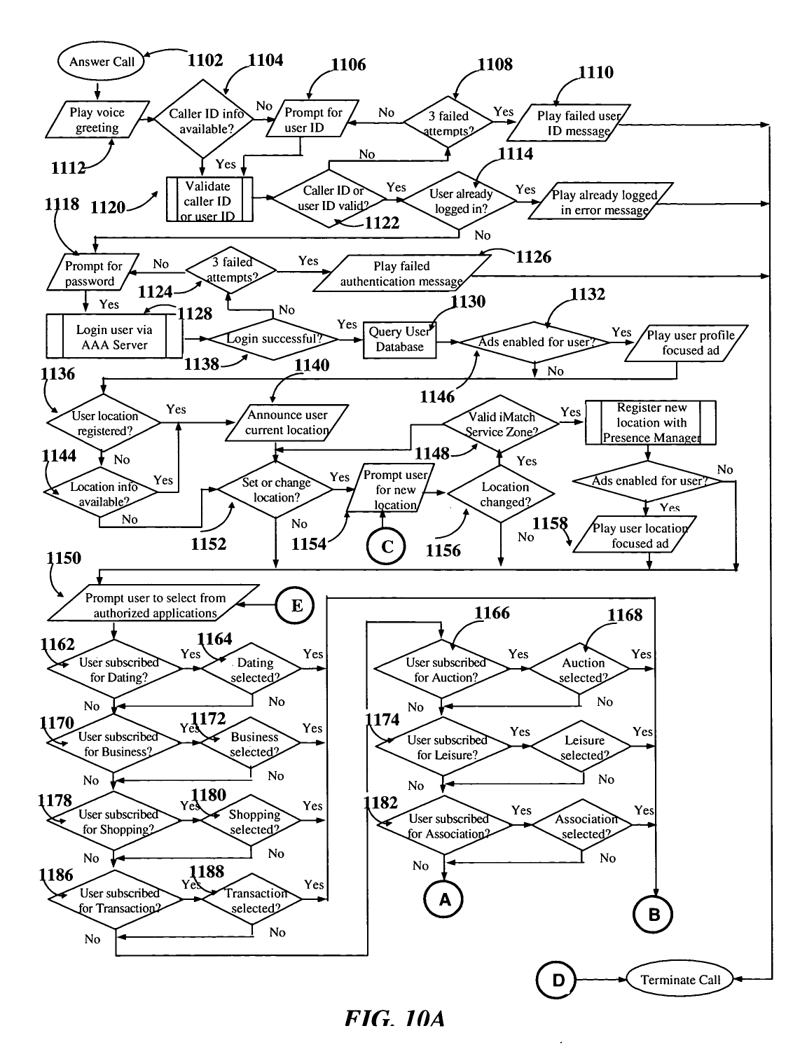

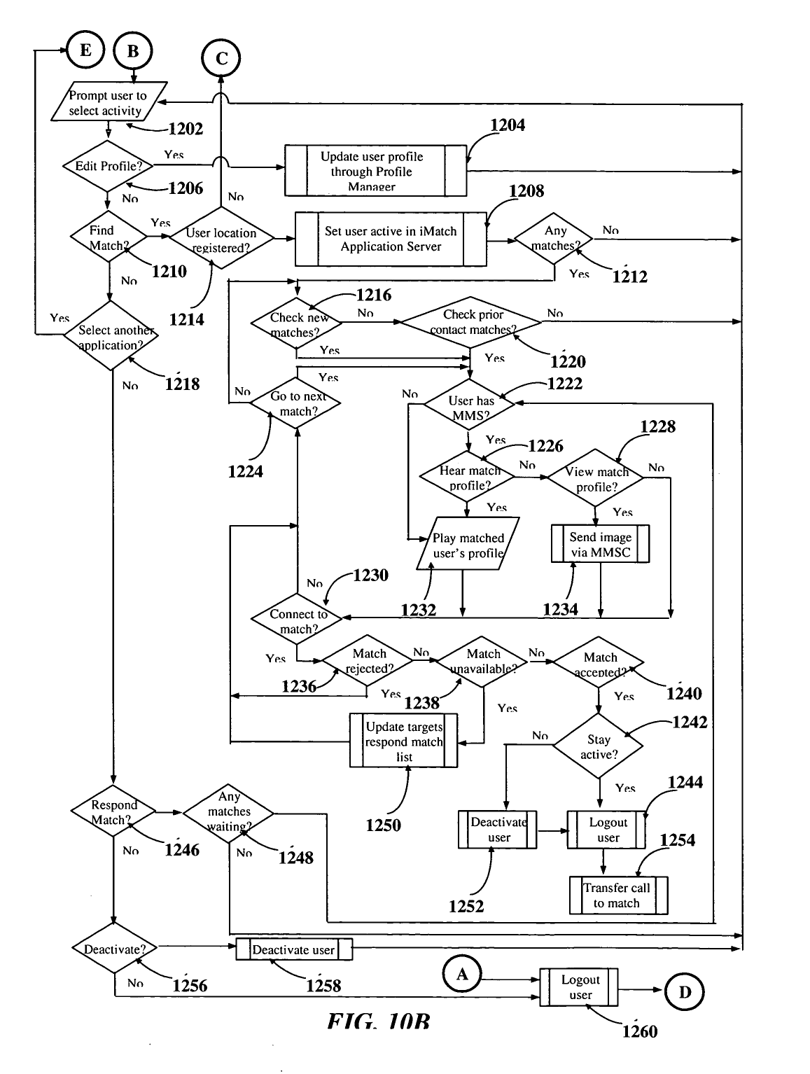

FIGS. 10A and 10B depict a flowchart illustrating a process of Interactive Voice Response (IVR) based communication and data transaction employed by one or more software applications residing in the Voice Portal of the system in a preferred embodiment of the present invention. It should be understood that, in order not to obscure the inventive features of the present invention, the following description of flow control is not an exhausting account of all the signals and control functions associated with the operation of the process. Thus a number of conventional operations and signals which are not essential for understanding the essence of the present invention are not depicted in the flowchart of FIGS. 10A and 10B since those signals and operations are well known to those of ordinary skill in the art. The IVR process is very similar to the iMatch client process as depicted in FIGS. 7A and 7B, and is mostly self-explanatory. A major differences in this case is however the determination of caller ID info 1104, which when available, is used as an alternate form of validation 1112 before prompting the user for password 1118. As in the case of iMatch client, ads are played when possible, based on the profile of the user 1130, as well as his current location 1152. Unlike the mobile data users with iMatch client, whose location is easily determined from the network connection information, the telephone users' location need to be determined by tying the caller ID with known locations 1140 or by explicitly prompting the user to add such info 1144. This information is critical for any effective match and location based services. The selection of applications are exactly the same as in iMatch client, but conducted through voice prompts in the decision boxes in 1154, 1156, 1162, 1164,, 1170, 1172, 1178, 1180, 158, 1160, 166, 1168, 1174, and 1176. The user can similarly choose several activities from the activity selection menu 1202. The only additional choice is that of “Deactivate” 1256, which basically allows the user to logout of the application (and terminating the call) while still staying in an active listening mode so that if matches are found subsequently, he/she will be notified immediately. This function is added to save the toll charges, which was not applicable for the mobile data users. The rest of the steps are very similar, except the capability of the system to handle MMAS 1222, which was not applicable for the mobile data users. For MMS users, they have the option to either view the profile as a MMS 1234, or hear the profile just like non-MMS users do with a regular phone. When a match is found 1244, the user is logged out of the application but the call is transferred to the match 1254.

1. A system and method for transmitting and processing information about location, presence and profile of a plurality of people and business entities in a plurality of areas of application, wherein said people and business entities are connected through a communication network between a plurality of host computers and a plurality of communication devices, or a peer-to-peer network that extends between a plurality of communication devices.
